(19) United States
(12) Patent Application Publication
(10) Pub. No.: US 2002/0068668 A1
(43) Pub. Date: Jun. 6, 2002

(54) Method for laser machining easy open, tear flexible packaging

(75) Inventors: Chris Chow, Somerset, WI (US); Dan Miller, Somerset, WI (US); Dave Hennig, Somerset, WI (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Laser Machining, Inc., Somerset, WI

(21) Appl. No.: 09/998,270

(22) Filed: Nov. 30, 2001

Related U.S. Application Data
(60) Provisional application No. 60/250,593, filed on Dec. 1, 2000.

(51) Int. Cl. B31B 1/16

(52) U.S. Cl. 493/62

(57) ABSTRACT

A method for producing an easy open, easy tear package formed of flexible single layer or multi-layered material using a laser. The user configures a microprocessor with the sheet size, score pattern, and material parameters. The microprocessor controls the laser to score the film material to a depth less than a full depth of the material. The microprocessor modulates the laser to create tear initiation areas at predetermined locations precisely on the score line, so as to create a starting point for initiating a tear to open the package along the score line after the package is sealed.

### CROSS-REFERENCE TO RELATED APPLICATION(S)

The present invention claims priority from provisional application, serial No. 60/250,593 filed on Dec. 1, 2000, entitled, “Method for Making an Easy Open, Easy Tear Sealed Package.”

### BACKGROUND OF THE INVENTION

The present invention relates to the manufacture of sealed packages which can be opened easily. More specifically, the present invention relates to a method of manufacturing easy-open, easy-tear sealed packages for storing both food and non-food items, using multiple laser processing steps. The present invention is particularly applicable for use with flexible packaging materials.

Flexible packaging has penetrated almost every sector of the manufacturing economy. The steady infiltration of flexible packaging in the past twenty years has led to the gradual conversion from metal cans, glass, paper and other rigid packaging structures to flexible packaging. The rapid growth in high performance, multi-layer film serves to underscore the growing demand for flexible packaging. Major factors contributing to this growth are the continuous improvement in cost-effective manufacturing processes and the seemingly unlimited potential for creating new film properties by combinations of various polymeric materials. The flexible packaging provides manufacturers with the ability to improve both the visual appearance and the functional performance of the packaging for both food and non-food items.

In food packaging, flexible packaging materials permit colorful packaging graphics, maintain fresh tasting food, allow both freezing and microwave heating, and can be resealed after opening. In non-food packaging, such as lawn and garden products, the packaging permits colorful graphics, maintains long shelf life, allows for resealing to limit odors, and resists punctures and tears.

With the continuous improvements in film properties, flexible packaging can be made thinner than ever before and yet be stronger and tougher than previous packaging. The strength and toughness of the newer films presents a new problem for consumers, namely the packages have become increasingly difficult to open. Furthermore, the strength of the packaging material leads to uneven or uncontrolled tearing during opening.

Prior art has taught the use of laser radiation to partially heat and evaporate film material on the film surface to create a precise score line on the thin film packaging. The technique for laser scoring was first suggested in U.S. Pat. No. 3,626,143. Scribing or laser scoring provides a line of “weakness” in the structure of the film to allow the film to be mechanically broken, such as tearing it by hand. The line of weakness contributes to a controlled-directional open. Generally, low energy, high power density beams are used to remove the material principally as vapor.

While the score line was intended to introduce a line of weakness to make the packaging easier to open, a deep score line is not always desirable. A score line that is cut too deeply will weaken the structure of the film, increasing the likelihood of an accidental burst, such that the packaging cannot withstand shipping and/or storage. Additionally, an overly-deep scored line may destroy the functional characteristics of the multi-layer construction of the film (such as by puncturing a vapor barrier layer). Moreover, the increased exposure to the laser required to produce the deep score line can lead to thermal distortion of the film material, resulting in film buckling when the roll stock is rewound.

Moreover, the start of the tear along the film edge is the most difficult part of the tear because it lacks the assistance of tear propagation or momentum. While the score line provides a line of weakness, if the flexible packaging is folded and sealed to form a pouch, the difficulty in initiating the tear along the score line is compounded by the double thickness of the scored film where the two ends of the film are sealed together. Once a tear is initiated along a score line, the momentum of the initial tear will assist the mechanical tearing operation by propagating the tear along the score line. However, due to the strength and durability of thin film packaging particularly at the sealed edge, not only is initiating the tear difficult, but directing the momentum of the initial tearing operation onto the score line is of principle concern.

Various packaging machines are available to fold the scored flexible films into packages. For a horizontal form-fill and seal machine, the film is typically folded top to bottom, with the side edges sealed first. The contents are introduced into the bag from the remaining opening, and then the remaining opening is also sealed. The air in the package may be evacuated during this final fill and seal process depending on the package contents. Typically, at least one or both sides of the score line are joined and sealed. For a vertical form-fill-seal machine or flowpack machine, the film is folded toward the middle from both sides and sealed at the back of the package. Then, one edge of the packaging is sealed while contents are introduced into the package through the remaining opening. Finally, the remaining opening is sealed. If the score line is made across the web, then the two edges of the score line may be sealed at the back of the package.

The sealed area amplifies the difficulty in initiating the tear to open the packaging. In order to make current thin film packaging easier to open, some manufacturers have incorporated a notch in conjunction with a shallow laser scored line. The notch assists in initiating the tear, while the score line serves to control the tear once it has been started. However, the notch is typically introduced in a separate machining process. By scoring and notching the film material in separate processes, alignment of the notch and the score line is difficult and often imprecise. Experience has shown that failure to align the notch and the score line leads to unpredictable results when the package is torn. For example, if the machined notch is not accurately aligned with the laser score line, the resulting tear may not be controlled at all. A sealed package with a tear line across the top, for instance, may not tear below the sealed edge, so that ultimately the package is not opened by the tear. Alternatively, in a package having a resealable “zipper” mechanism arranged below the sealed edge to allow for resealing after opening, a misaligned notch may cause the material to stretch and tear on the zipper itself, thereby compromising the zipper seal. Furthermore, the tear may result in an opening significantly above the resealable zipper. The remaining film material may then impede access to the zipper. The alignment of the notch and the score line must be precise in order to function properly. In many instances, separate machining processes do not achieve the desired easy open packaging.

U.S. Pat. No. 4,139,643 and U.S. Pat. No. 5,630,308 have introduced multiple score lines at sufficient separation so that the mechanically produced notch is located at a location between the score lines. However, creating two score lines requires twice as much energy as a single score line. Consequently, scoring multiple lines increases the costs of production significantly. Additionally, multiple score line production increases the cost of the equipment, increases the energy consumption of the process, increases the size of the score area and consequently amplifies the scoring error, and finally uses more of the film for the tear area.

Within the flexible packaging industry, there is a need for any easy open or easy tear package that can be readily manufactured without compromising either the durability of the packaging or the functionality of the multi-layered material. Additionally, there is a need for an easy open, easy tear package that can be manufactured inexpensively while still providing a controlled tear with easy tear initiation.

### BRIEF SUMMARY OF THE INVENTION

The present invention teaches a method for manufacturing an easy open, easy-tear flexible package by creating a score line having precisely aligned, substantially weakened spots at the initial tear. The method involves scribing one or more score lines having cut through or substantially weakened spots at predetermined locations along at least one score line using one or more controlled lasers. Using flexible film materials, the method includes the steps of scoring the film with a laser, producing a cut-through spot, a perforated area, or a substantially weakened spot at predetermined locations along the score line, folding the flexible film to align cut-through, perforated or weakened spots, and sealing the edges to form a sealed pouch. The depth of the score line is determined by the type of thin film material and the intended function of the material. In the extreme case, a laser score line may be at minimal scoring depth.

### BRIEF DESCRIPTION OF THE DRAWINGS

FIG. 1 is a block diagram of the laser scoring system of the present invention.

FIG. 2 illustrates a sheet of film material having score lines and cut-through lines.

FIG. 3 illustrates the sheet of film material of FIG. 1 in a folded position.

FIG. 4 illustrates the folded sheet of FIG. 2 with the edges sealed to form a pouch.

FIG. 5 is an alternative embodiment illustrating a scored pouch of film material having a single score line extending in a straight line from edge to edge.

FIG. 6 is another embodiment illustrating a scored pouch of film material having two parallel scored lines and a notched cut-through pattern along the sealed edge.

FIG. 7 illustrates a wedge of cheese wrapped in a scored pouch of film material having two parallel scored lines and associated cut-through lines on a sealed edge.

FIG. 8 illustrates a spout opening in a load bearing container.

While the above-identified drawing figures set forth a preferred embodiment, other embodiments of the present invention are also contemplated, some of which are noted in the discussion. In all cases, the disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

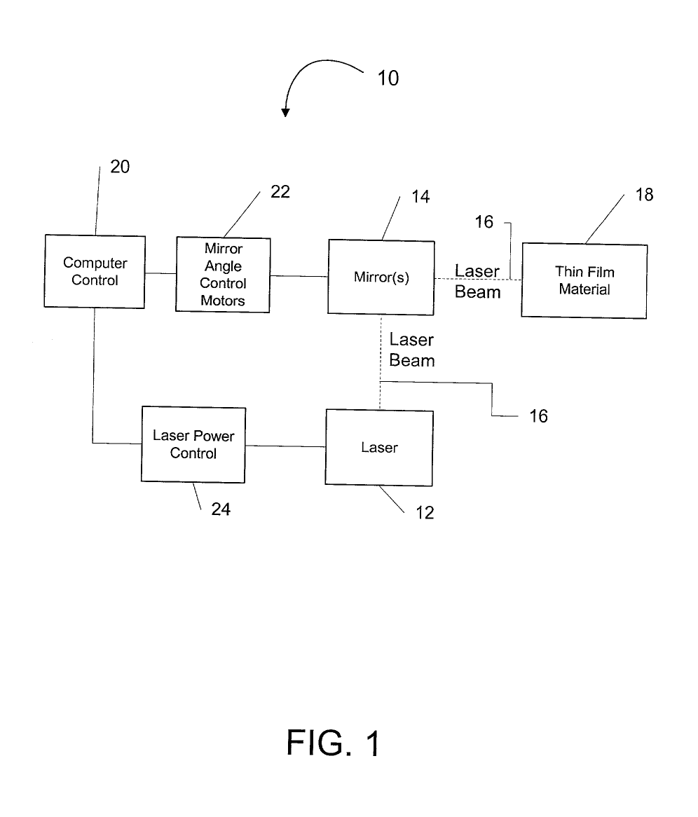

As shown in FIG. 1, a laser scoring system 10 employs a laser 12 and mirror or mirrors 14 to direct a laser beam 16 onto the surface of a film material 18. A computer or microprocessor 20 controls the score pattern by controlling the mirror angle control motors 22 according to a pre-programmed score pattern. The pre-programmed score pattern typically includes both the repeated length of each sheet of the thin film material 18 and the pattern of score line. In the simplest case, the score line is a straight line in the web direction, where the mirror is fixed and the laser is focused through a focusing lense. Additionally, the microprocessor 20 controls the laser power adjust mechanism 24 so as to adjust the power of the laser beam 16.

The laser beam 16 may be a fixed laser or a galvo-laser, depending on the score pattern. Typically, a fixed laser may be used to scribe a straight line relative a moving web, whereas a galvo-laser is desirable for scribing a curved line, a cross-web score line, or a pattern onto the moving web.

Generally, the power level of the laser beam 16 determines the depth of the score line cut into the thin film 18. However, with some thin film materials, increasing the power level of the laser beam 16 structurally weakens the thin film material at a molecular level without noticeably scoring the thin film 18. Thus, the laser beam 16 may be used on a thin film material to weaken structurally a package formed from the thin film material so that the packaging is easy to tear.

The computer 20 may simultaneously control mirror angle control motors 22 and laser power control 24 for multiple lasers 12 to allow for complex patterns, parallel or overlapping score lines on the thin film material 18.

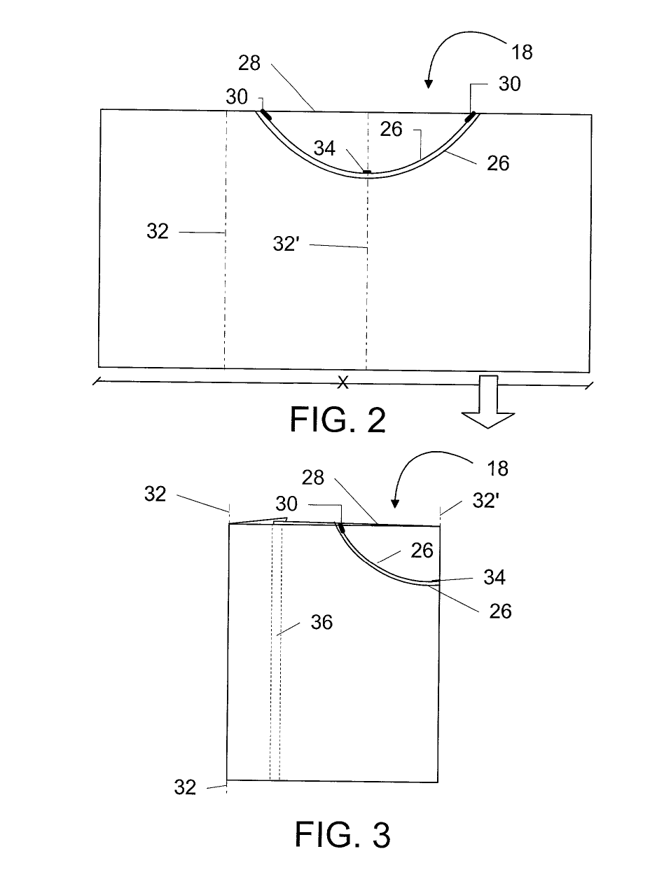

The system 10 is used to scribe or score a thin film material 18 as shown in FIG. 2. The thin film material 18 shown is a section of a moving web (moving in the direction of the arrow), which typically unwinds from a roller on one side of the laser system 10, passes under the laser beam 16, and is rewound on the other end. The moving web is held tight using rollers so that the web material does not flap or flutter during operation.

The thin film material 18 may be any printed or coated plastic or cellulose film, paper or Aluminum foil material. Additionally, the system 10 may be used to score any film, paper, foil, metallized material or laminate, such as those produced by adhesive, wax and extrusion lamination. Moreover, the system 10 may be used to score mono and co-extruded plastic films for special applications. Suitable materials include, but are not limited to, plastic and polymeric materials such as polyethylene (PE), linear and low-density polyethylene (LLDPE and LDPE), polyethyleneterephthalate (PET), oriented polypropylene(OPP), or other polymer. Similar polymers such as, for example, metallocene doped polyethylene are also within the scope of the present invention. Generally, the present invention may be used with either multi-layer homogenous or non-homogenous film materials or single-layer film materials of uniform composition. Generally, any type of flexible packaging material may be laser scored as taught by the present invention. For the purpose of this disclosure, thin film material 18 may be any flexible packaging material of either multiple layers of different compositions or a single layer of uniform composition.

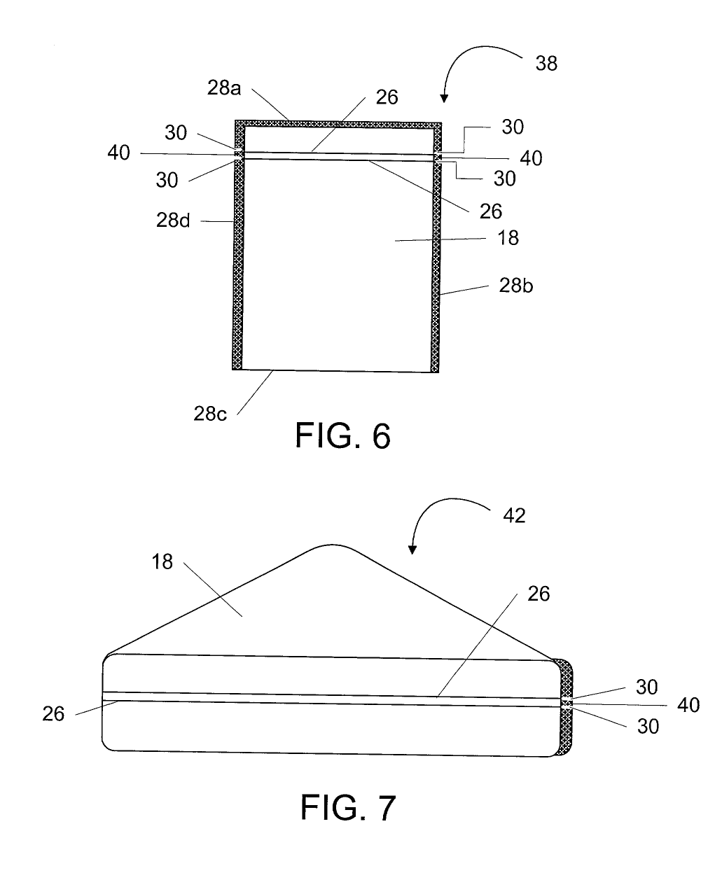

To form the easy open package, laser beam(s) 16 scribes score line 26 having a depth less than the full thickness of the thin film 18. The mirror angle control motors 22 direct the beam along a pre-programmed pattern. As shown in FIG. 2, two laser beams are directed onto the thin film material 18 to scribe parallel score lines 26 extending from a top edge 28 toward the center of the sheet of thin film 18 and returning to the top edge 28 in a curve extending less than the full length x of the edge 28. Alternatively, the score lines 26 may extend the full length x of the thin film material 18, as shown in FIGS. 5 and 6.

Cut through areas 30 are formed by the laser by modulating the laser's power to a level sufficient to cut entirely through the thin film at predetermined points precisely on one of the score lines 26. The cut through areas 30 can be created by the same laser that scribes the score line 26 during the same scribing process by modulating the laser's power level. Alternatively, a second laser beam may be provided to create the cut through areas directly on the score line and during the same scribing process. In the preferred embodiment, one laser beam scribes the score line 26 and its associated cut through areas 30 during a single process on a moving web of thin film material.

Generally, to carve a score line 26, the laser beam's energy level must be maintained at a constant energy per unit distance traveled by the focal point. Generally, the mirrors 14 are galvo mirrors which can be adjusted using the mirror angle control motors 22 to selectively position the focal point of the laser beam 16. If only one score line 26 (as shown in FIG. 5) is presented, then the cut through area 30 would be located on the score line 26. If two score lines 26 are presented, then the cut through area 30 may be located precisely on either score line 26. In the preferred embodiment, the cut through area 30 is located on the score line 26 closest to the edge 28.

First, the laser makes a cut-through area 30 extending the full thickness of the thin film material 18 at edge 28. Then, the laser power is modulated to produce a score line 26 cut less than the full thickness of the thin film material 18 extending in a curve from edge 28 toward the center and back toward the edge 28. Finally, the laser is again modulated to perform a cut-through area 30 near the edge 28. While the score line 26 need not be symmetric, in the preferred embodiment, the score line 26 should be symmetric about the fold line 32′ and should extend less than the full width x of the flexible sheet 18.

As the web of thin film material 18 advances under the laser beams 16, the mirror angle control motors 22 and the laser power control 24 are adjusted according to the cut pattern and the desired position of the cut through area 30. If a single laser beam is used to provide both the cut through 30 and the adjacent score line 26, the power of the laser 12 must be adjusted by the computer 20 to provide a more powerful beam at the cut through areas 30. Alternatively, a second laser beam can track the first laser beam and pulse to provide the cut through areas 30 at the required locations.

As previously indicated, the score lines 26 provide lines of weakness in the thin film 18 to assist in the tearing of the packaging. The cut through areas 30 provide a starting point for the mechanical tear. Precise location of the cut through areas 30 on the score line 26 maximize the effectiveness of the score line 26 by maximizing the shear stress of the initial tear at the score line 26 directly adjacent the cut through area 30. Thus, the likelihood of an errant tear and resulting spillage is minimized. By locating the cut through area 30 precisely on the score line 26, tearing of the packaging maybe initiated at the cut through area 30, and the momentum of the tear translates precisely onto the score line 26 so that the tear proceeds along the score line.

As shown in FIG. 2, the cut through areas 30 are positioned on the score line 26 that is closest to the edge 28. The cut through areas 30 are located on the score line 26 such that two cut through areas 30 intersect the edge 28.

The cut through area 30 need not extend the full thickness of the film material. The cut through area 30 may be a notch or cut out, a deep perforation, or even a highly damaged area precisely on the score line. Typically, the type and depth of the cut through 30 or highly damaged area 34 depends on the packaging arrangement, the location of the seal relative to the score line, the type of film material, and numerous other factors.

With respect to the package depicted in FIGS. 2 and 3, a highly damaged area 34 may be located on the score line 26 such that it intersects the fold line 32′. In this particular configuration, the highly damaged area intersects the fold line 32′ is also bisected by the fold line 32′, and the score lines 26 are symmetric about the fold line 32′. Thus, the laser may be modulated to provide a cut through area 30 (extending entirely through the film material), a score line 26 and a highly damaged area 34 (extending less than the full thickness of the film material) on the score line 26 according to a predetermined score pattern.

A highly damaged area 34 is an area or spot on the film material that is rendered structurally weaker than the surrounding film material due to the laser beam. With respect to the highly damaged area 34 located precisely on the score line, as previously indicated, some materials may be weakened structurally by the laser beam without exhibiting a deeper score or cut through. Nevertheless, the highly damaged area 34 presents a tear initiating locating for initiating a tear precisely on the score line 26.

While the previous discussion has focused primarily on the cut through areas 30, particularly with respect to the sealed edges, the package may be rendered easy to open by generating highly damaged or even perforated areas, rather than a cut out 30. With some film materials, a perforation is more desirable than a cut out on the sealed edge. The perforation simply works better with some materials than a notch or cut out. Moreover, with some types of fill and seal machines, the score line may not intersect a sealed edge at all, so the highly damaged area 34 maybe used instead of the cut through for initiating the tear on the score line 26.

Generally, the cut through areas 30 extend only a fraction of the distance of the score line 26. The cut through areas 30 are preferably shorter than the depth of the seal area when the four edges of the package are sealed around an item. Thus, the cut through area 30 should not extend into the sealed package area because the integrity of the seal would be compromised by the cut through area 30.

Fold lines 32 and 32′ are included in the illustration to show the lines on which this embodiment of the thin film packaging is folded. Different score line 26 patterns and different fold lines 32 may be used depending on the shape of the packaging and the type of fill and seal machine. For example, FIGS. 2-5 depict a package formed using a vertical fold-fill and seal machine. After the score line 26 and cut-through areas 30 are produced by the laser 12, the flexible sheet 18 is folded along the fold line 32 as shown in FIG. 3.

As shown in FIG. 3, the thin film 18 is folded along the fold lines 32 and 32′. The symmetric score lines 26 are aligned in the fold operation, such that score lines 26 and cut through areas 30 align precisely. The positioning of a highly damaged area 34 directly on the score line 26 over fold line 32′ provides a substantially weakened area on the packaging along the folded edge without compromising the contents of the package itself. Thus, the package may be opened by tearing at either the cut through area 30 or the highly damaged area 34 along the edge.

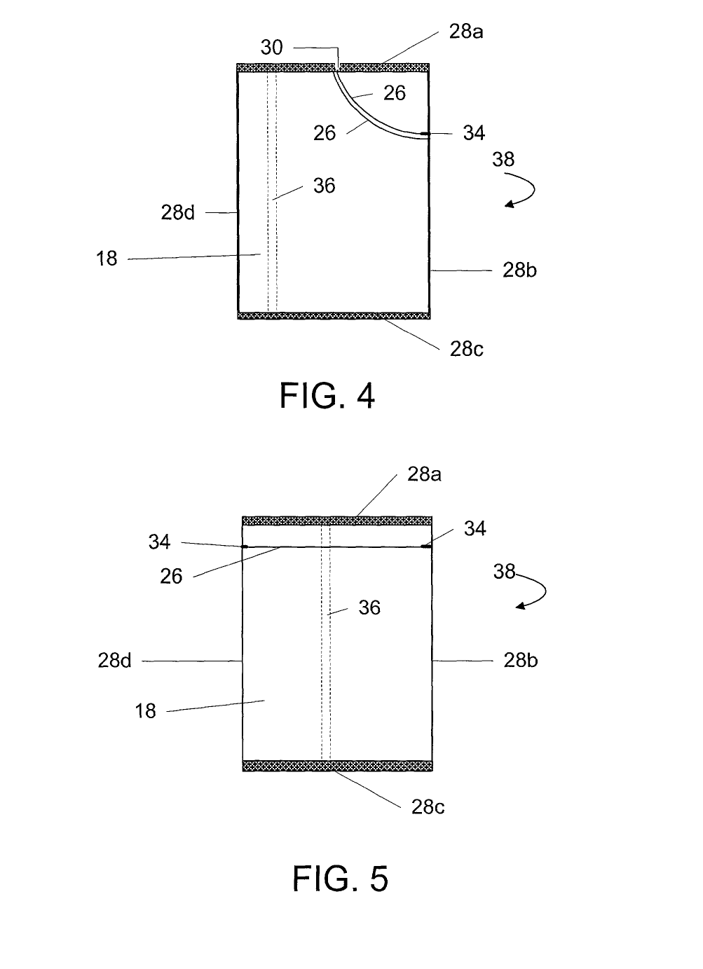

As shown in FIG. 4, the thin film 18 is then sealed along its edges 28a and 28c and along overlap 36 to form a pouch 38. Cut through areas 30 are part of the sealed edge 28a. The locations of the cut through areas 30 on the score line 26 at the sealed edge 28a provides a starting point for the mechanical tear. The tear may be initiated at either cut through area 30 or at a highly damaged area 34 on the score line at edge 28b. As previously indicated, the precision laser alignment of the cut through area 30 and highly damaged area 34 directs the tearing or shear forces directly onto the adjacent score line 26 during tearing, maximizing the opportunity for a controlled tear and making the packaging easy to open.

Typically, each individual sheet 18 is folded sealed on at least two sides. Then, the food or other material is delivered into the resulting pouch Finally, the air may be evacuated as the remaining side is sealed. The sealing and filling process may be performed by any known method, provided the sealing process aligns the laser score lines 26 and cutouts 30 as described.

When the flexible sheet 18 is torn along score line 30, an opening forms adjacent to the score line 26. When sheet 18 is folded and sealed into a pouch 38, tearing along the score line 26 reveals the contents (not shown) of the pouch 38.

The score line 30 must be cut to a depth less than the thickness of the flexible sheet 18. The typical thickness of the flexible sheet material is within a range of 1 mil to 20 mils. In the preferred embodiment, the score line 26 should be cut to a minimum depth, which is largely dependent on the thickness of the sheet material and the makeup of its layers. For instance, in the case of a film layer of approximately 1 mil, the score depth probably would approach 0.2 mils. In food packages, the top layer, for example, may consist of polyester or polypropylene to a depth of about 0.5 mils. The next layer may consist of one or more oxygen layers, followed by a layer of metallocene, and a layer of polypropylene of polyethylene. The precise order of the layers depends on the type of thin film sheet material, and is unimportant except for determining the depth of the score line 26.

In some cases, it maybe important to prevent the laser beam 16 from scoring particular layers. In the case of food packaging, damaging the oxygen layer by scoring too deeply may cause the package contents to spoil. The computer 20 can be used to control the depth of the score line 26 according to the type of material, the material thickness, the particular functionality of the material and so on. Generally, the depth of the score line 26 is the minimum depth required to form a line of weakness without compromising either the functionality of the thin film 18 or the resilience of the pouch 38. The laser scoring and cut-through technique of the present invention can be performed without scoring the thin material 18 to any appreciable depth on the film surface, provided the laser radiation weakens the bonds along the score line 26.

As shown in FIG. 5, the score line 26 may extend the entire length x of the thin material 18, such that in the folded position, the score line 26 extends from edge 28b to edge 28d with corresponding highly damaged areas 34 at edges 28b, 28d. In the embodiment shown, a single fixed laser may be used to generate the score line 26 and the highly damaged areas 34. In this embodiment, the highly damaged areas 34 are located on edges 28b and 28d to facilitate the initial tear; however, the edges 28b and 28d are not sealed edges. Thus, the highly damaged areas 34 should not penetrate to the full thickness of the film material. Nevertheless, the highly damaged areas 34 should be more damaged than the rest of the score line 26.

In FIG. 6, a package 38 as formed by a horizontal form, fill and seal machine is depicted. The thin film material would typically be scored along the top and the bottom of the moving web, then folded along a midline so that the two score lines are aligned. As shown, the package 38 has two score lines 26 and corresponding cut out areas 30 for each score line 26. In this embodiment, as in FIG. 5, each of the score lines extends from edge 28b to edge 28d. A cut out area 30 is provided on the sealed edges 28b, 28d for each of the score lines 26. Between the cutout areas 30, a small area of thin film material 18 is left. After sealing of the pouch 38, the small area of thin film material 18 provides a tab 40 to assist in opening the packaging.

As shown in FIG. 7, the invention may be used with shapes other than rectangular pouches. As shown in FIG. 7, a wedge 42, such as a wedge of cheese, is wrapped in thin film material 18. Score lines 26 and cut out areas 30 can be generated with the laser 12 either prior to or after wrapping of the object. As shown, the tab 40 is created on the sealed edge between the two cut out areas 30 so as to provide an easy tear tab for opening the packaging. The cut out areas 30 are precisely aligned with the score lines 26 so that stresses placed on tab 40 are directly translated to the score line 26 to open the packaging easily. The wedge wrapper could also be implemented using a single score line 26 and a single corresponding cut out area 30.

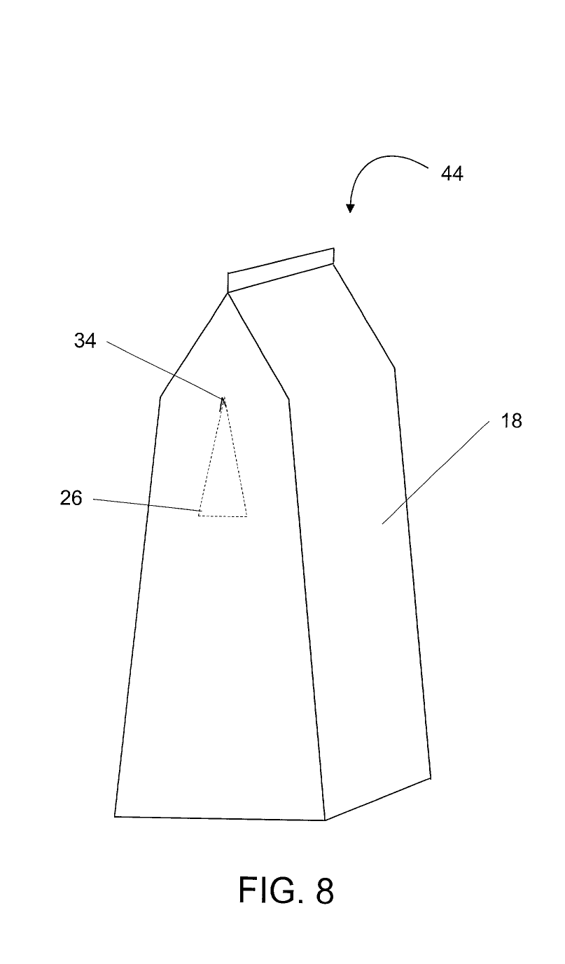

As shown in FIG. 8, a load bearing package 44 formed of thin film material (or multi-layered stretch material) has a score line 26 and a punch through area 46. Typically the load bearing package 44 is intended for rock salts, fertilizer, livestock feed bags, and other types of bulk materials. Due to the weight of the bulk materials, a score line 26 extending across the entire package would make the bag likely to burst or break during handling. By locating the score line on a single panel of the packaging material, and by locating a highly damaged area 34 on the score line, the large package 44 can be lifted and carried by the top sealed edge without inadvertently tearing the package open. At the same time, the scored line 26 together with the highly damaged area provide a punch out for easily opening the package.

While in the preferred embodiment, the cut through areas 30 extend the full thickness of the material, in the load bearing bag situation, there may be no sealed edge on which to position the cut through area 30. As shown, the score line 26 is presented as a dotted line, and the highly damaged area 34 is simply a deeper score area which extends almost the entire thickness of the film material 18. The punch through area 46 is significantly weaker than the score line 26 or the surrounding material, thereby providing weak location precisely located on the score line 26 to assist in initiating the mechanical tearing.

The embodiment shown controls the mechanical tear with the score line 26, and begins the tear with a highly damaged area 34 instead of a cut through area as in the earlier figures. In effect, highly damaged area 34 requires some tearing before the stress reaches the score line 26; however, the highly damaged area 34 provides a location of substantial material weakness to assist in initiating the tear.

While the invention has been described with respect to a score line and cut through or highly damaged areas, in some instances it may be advantageous to provide a score line having uneven scoring depths so as to emulate a perforation. For example, in some packaging environments, the consumer may begin to tear the packaging, stop, and then resume tearing. With some film materials, the cut through area 30 assists in initiating the tear, and the precise location of the cut through area 30 on the score line 26 directs the tearing momentum directly onto the score line 26. However, if the tearing process is stopped, the momentum is lost to the consumer, and resuming the tear may cause the packaging to stretch rather than to tear further along the score line 26. Substantially perforated score lines 26 allow the tear to be stopped and restarted. In effect, the tear momentum may be lost and regained.

The laser score line 26 can also be a laser perforating line. The laser cut-lines can also be laser cut-patterns or a combination of the cut-lines with cut-patterns. Additionally, though cut through areas 30 have been described with respect to a line, it is possible to provide the cut through areas by notching or cutting shapes such as triangles or diamonds along the score line 26. Such shapes provide similar cut through areas for easily initiating a tear.

The sealing of the flexible material can be performed using an adhesive, a heat process, or any known sealing method. In addition, the scoring of the material can be performed on asymmetric pieces of the flexible material, on large sheets of the material, on uncut pieces of the material, and even on already sealed packages. The laser scoring process may take place at the same time as the fold and seal process such that the same fold and seal machine houses the laser. The sealing process may be a heat adhesive that is sealed by a laser.

In addition to the pouch and load-bearing container shown, the container can also be made into a variety of configurations such as tubes, wraps, etc. (not shown). While the present invention has been described with respect to the rectangular pouch 38, the wedge (FIG. 7), and the load bearing container (FIG. 8), the present method is equally applicable to other shapes such as triangles, circles, cartons, etc. In the preferred embodiment, the score line 30 should extend from a point along a sealed edge of the pouch or container, such that a cut-through slit along the sealed edge is aligned with the score line.

In the embodiments shown, any number of closely parallel score lines may be used. In addition, score lines could be place at multiple locations along the packaging, to provide multiple alternative for opening. The number of parallel score lines (whether single or multiple) may depend on the tear strength of the material, on the material's thickness, and even on the desired tear out. The more tear resistant the material, the more important it is to locate the cut through area 30 or highly damaged area 34 directly on the score line to initiate the tear. Such cut through areas or highly damaged areas may be provided on one or all of the score lines to render the packaging easy to open.

The present method provides a process for making an easy tear container. The process includes selecting a sheet of material of a predetermined area, scoring the sheet of material, scribing tear initiation areas (cut through lines, highly or substantially damaged areas, or perforations) with the laser at predetermined locations precisely on the score line, folding the sheet along the fold line causing the score line and cut-through lines to align, and sealing the open sides. The tear initiation area provides the a structurally weak spot or area for initiating the tear on the laser scored line 26.

Additionally, with respect to the thin film material, it is known in the art of food packaging that certain types of foods, such as red meat, require exposure to a small amount of oxygen in order to maintain the proper visual appearance. Commonly, multilayer film material is chosen that has a permeable oxygen layer, which allows a small amount of oxygen to access the food. With the laser score technique of the present invention, or with a separate laser process, it is possible to create the score line so as to puncture a vapor layer at a select location, if the selected film material does not allow for vapor transfer through the film. Specifically, an impermeable multilayer film may be made permeable via a microscopic hole in the substrate created by the laser beam, thus allowing a small amount of oxygen to access the food particle through an otherwise impermeable film. In the present invention, the microscopic hole may be accomodated by modulating the score line 26 such that at one point along the score line, the laser beam 16 penetrates the vapor layer of the thin film material 18.

With respect to resealable packaging, the score line may be positioned at any location on the package material, and the line may be scribed either before, after or at the same time as the zipper mechanism is attached to the package material. The score line allows for precision tearing, and easy access to the zipper opening to access the contents of the packaging. By locating the tear initiation area (cut out, perforation, or highly damaged area) precisely on the score line, the package can be opened easily, the zipper fully and accurately exposed, and the contents accessed without compromising the zipper seal and without leaving excess material in the way of the zipper.

While the zipper mechanism is not expressly depicted in the figures, the zipper would be located adjacent the score line so that a minimum amount of excess material would be left to maintain the zipper attachment to the rest of the pouch.

Having illustrated and described the principle of the present invention of a multi-step laser scoring process for producing easy open flexible packaging, it will be apparent to a worker skilled in the art that the invention and the scoring technique may be modified in arrangement and detail (including alternative thin sheet materials, different form and fill machines, and the like) without departing from the spirit of the invention.

Although the present invention has been described with reference to preferred embodiments, workers skilled in the art will recognize that changes may be made in form and detail without departing from the spirit and scope of the invention.

1. A method for producing an easy open package, the method comprising:
scoring a film material with a laser beam to form a score pattern, the score pattern penetrating the film material to a depth less than a full thickness of the film material; and
modulating the laser beam at predetermined locations precisely on the score pattern during scoring to penetrate the film material to a greater depth than the depth of the score pattern to form tear initiating areas.

2. The method of claim 1, wherein the tear initiating areas are positioned at a midpoint of the score pattern and at endpoints of the score pattern, the midpoint and the endpoints determined according to a predetermined sheet size.

3. The method of claim 1, wherein the tear initiating areas extend the full thickness of the film material.

4. The method of claim 1, wherein the tear initiating areas have a greater structural weakness than the score pattern.

5. The method of claim 1, further comprising:
cutting a sheet from scored film material from a web of scored material to form an individual sheet, each individual sheet having the score pattern; and
folding each individual sheet on a fold line such that ends of the score pattern are aligned.

6. The method of claim 5, further comprising;
sealing the sheet around a substance to form a sealed container.

7. The method of claim 6, wherein at least one of the tear initiating areas is positioned on a sealed edge of the sealed container.

8. The method of claim 1, wherein the easy open package is flexible.

9. The method of claim 1, further comprising:
carving a second score pattern parallel to the first score pattern on the film material with a second laser beam, the second score pattern penetrating the film material to a depth less than the full depth of the film material.

10. The method of claim 9, further comprising:
modulating the second laser beam at predetermined locations along the second score pattern to penetrate the film material to the full depth of the film material on the second score pattern to form second tear initiating areas.

11. The method of claim 10, wherein the second tear initiating areas have a greater structural weakness than the second score pattern.

12. The method of claim 1, wherein modulating comprises:
controlling an energy level of a laser beam by changing energy per unit distance traveled by a focal point of the laser beam.

13. A method for producing an easy tear package, the method comprising:
etching one or more score lines on a film material using one or more lasers, each score line penetrating the film material to a depth less than a full thickness of the film material; and
highly damaging the film material at predetermined locations precisely on one or more of the score lines with the one or more lasers to form tear initiation areas.

14. The method of claim 13, wherein highly damaging the film material comprises:
modulating a power level of the laser to structurally weaken the film material precisely on the score line.

15. The method of claim 13, wherein highly damaging the film material comprises:
modulating a power level of the laser to cut entirely through the film material, the cut through extending a full depth of the film material.

16. The method of claim 13, wherein the steps of scoring and highly damaging the film material further comprise:
scoring one score line using a first laser; and
highly damaging the one score line using a second laser, the second laser being precisely aligned with the first laser, the second laser operating at a higher power level than the first laser.

17. The method of claim 13, wherein at least one initiating tear area extends a full thickness of the film material.

18. The method of claim 13, wherein at least one tear area extends to a tear depth that is less than a full thickness of the film material and greater than the depth of the score line.

19. The method of claim 13, further comprising:
separating the film material into sheets;
folding each sheet on the fold line; and
sealing each sheet around a substance to form a sealed pouch such that the tear areas are positioned on sealed edges of the sealed pouch.

20. The method of claim 13, wherein at least two tear areas are positioned at endpoints of each of the parallel score lines, the cutouts forming tear out tabs at end locations of a pair of parallel score lines.

21. The method of claim 13, wherein the parallel score lines are straight lines extending a full length of an individual sheet of the film material, the full length determined according to a predetermined length of the individual sheet.

22. The method of claim 13, wherein the parallel score lines are curved lines extending less than a full length of an individual sheet of the film material, the full length determined according to a predetermined length of the individual sheet, wherein each curved line has two ends positioned on an edge of the individual sheet prior to folding.

23. The method of claim 13, wherein prior to scoring the film material, the method comprises:
configuring a sheet size in a microprocessor according to dimensions of a package;
configuring specifications of the film material;
configuring a score pattern according to a desired opening in the package;
storing the configured sheet size and the configured score pattern in a data file accessible to the microprocessor; and
controlling programmatically a laser beam focal point and a laser beam energy level according to the configured sheet size, the configured score pattern, and the specifications of the film material as the film material is advanced relative to a laser.

24. A method of producing an easy tear package, the method comprising:
scoring one or more score patterns with one or more lasers on a formed and sealed package, each of the one or more score patterns having a score depth less than a full thickness of the package material; and
scribing tear initiation areas with a laser precisely on one or more score patterns on the sealed package, the tear initiation areas being significantly weaker than the score pattern.

25. The method of claim 24, wherein the scoring and scribing process are performed within a packaging machine.

26. The method of claim 24, wherein the tear initiation areas and the score patterns do not intersect a sealed edge of the sealed package.

27. The method of claim 24, wherein the tear initiation areas are positioned at unsealed edges of the sealed package and wherein the tear initiation areas extend to a tear depth less than a full thickness of the film material.

28. The method of claim 24, wherein the tear initiation areas are perforated areas.

29. The method of claim 28, wherein the perforated areas do not penetrate through the full thickness of the film material.

30. The method of claim 24, wherein the tear initiation area is a cut through area precisely on the score pattern.
